(19) United States
(12) Patent Application Publication
(10) Pub. No.: US 2011/0298985 A1
(43) Pub. Date: Dec. 8, 2011

(54) METHODS FOR ENHANCING THE STABILITY AND CONTRAST RATIO OF THE DISPLAY DEVICE

(75) Inventors: Chao-Shin Wang, Taipei County (TW); Chien-Hung Liu, Taichung County (TW); Bomin Weng, Taipei County (TW)

(73) Assignee: HANNSTAR DISPLAY CORP., Taipei City (TW)

(21) Appl. No.: 12/962,728

(22) Filed: Dec. 8, 2010

(30) Foreign Application Priority Data
Jun. 7, 2010 (TW) 099118450

(51) Int. Cl. H04N 5/14

(52) U.S. Cl. 348/673; 348/E05.062

(57) ABSTRACT

A method of enhancing a contrast ratio of a picture of a display device, comprising steps of providing the display device having a light source; continuously receiving plural display signals; and turning off the light source when the display device has a buffer time during which each of the continuously received plural display signals has a picture brightness equal to zero.

### FIELD OF THE INVENTION

The present invention relates to a method for enhancing a contrast ratio for a display device and a method for enhancing a stability for a display device, and specially relates to a method for enhancing a contrast ratio for a liquid crystal display (LCD) device and a method for enhancing a stability for a LCD device.

### BACKGROUND OF THE INVENTION

In recent years, the technologies of the LCD have been making a lot of progresses and simultaneously the production costs continuously go down. Accordingly, the LCD almost replaces the traditional cathode ray tube (CRT) in the market of the monitors. As the technologies of the LCD are being promoted, the market of the LCD television (TV) grows quickly, and the expected performances for the LCD TV become higher and higher. There are several advantages for the LCD TV compared with the traditional CRT TV, e.g. ultra thin thickness, bigger display screen, higher resolutions, etc. However, there exists a drawback for the LCD TV, e.g. lower contrast ratio than the traditional CRT TV. This drawback results from the actual condition that the backlight of the LCD TV is always turned on. When the LCD TV displays the dark picture, the light from the backlight module can hardly be completely blocked by the liquid crystals due to the polarization properties of the liquid crystals, and accordingly the slight light leakage occurs. Therefore, how to further enhance the contrast ratio becomes one of the major technical issues to be solved in the LCD technologies.

Nowadays, the current techniques for enhancing the brightness usually adopt the method of adjusting the brightness of the backlight module in real time according to the overall luminance of the instantaneous picture. For example, the brightness of the backlight module is adjusted to be lower in real time, when the overall luminance of the picture to be instantaneously displayed is lower; the brightness of the backlight module is adjusted to be higher in real time, when the overall luminance of the picture to be instantaneously displayed is higher. However, this kind of methods are liable to flash and be suddenly bright and dark, and result in the discomfort of the audience and the issue of visual fatigue. Meanwhile, the fast and frequent adjustments on the brightness of the back light module would significantly reduce the lifetime of the back light module.

On the other hand, the display device is liable to shut down, malfunction, flicker or non-uniformly display the full white picture, when turned on in a low-temperature environment, especially in the cold area.

To solve the above problems, the inventor has done a lot of deep researches and analyses through numerous experiments and improvements, and finally developed the new methods able to effectively address the above problems so as to enhance the contrast ratio of the picture in the display device, to enhance the stability of the light source of the display device, and to promote the display quality of the display device.

### SUMMARY OF THE INVENTION

The methods for enhancing a contrast ratio of a display device and for enhancing stability of a light source of a display device are provided in the present invention, and can promote the contrast ratio of the display device and solve the problems that the display device shuts down, malfunctions, flickers or non-uniformly displays the full white picture when turned on in a low temperature environment.

In accordance with one aspect of the present invention, a method for enhancing a contrast ratio of a picture having a picture brightness in a display device is provided. The method comprises steps of providing the display device having a light source; continuously receiving plural display signals; and turning off the light source when the display device has a buffer time during which each of the continuously received plural display signals is representative of the respective picture brightness equal to zero.

In accordance with another aspect of the present invention, a method for enhancing a stability of a light source of a display device is provided. The method comprises providing the display device having the light source; and maintaining a maximum brightness of the light source for a specific period of time when the display device is initiated to be turned on.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the timing schedule for the voltage of the light source, the voltage of the brightness control and the voltage of the inverter when starting a display device in the first embodiment of the present invention;

FIG. 2 is the schematic diagram showing the brightness of the display signal and that of the light source for a display device in the third embodiment of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### First Embodiment

In this embodiment, when a display device, e.g. a liquid-crystal-display television (LCD TV), is initiated to be turned on, a driving unit, including an inverter, of a light source, e.g. a back light source, in LCD TV will drive the back light source to maintain a brightness at a maximum brightness of the back light source for at least a specific period of time, which can be set to be longer than 0.5 second and is set to 2 second in this embodiment. This method not only can conform to the specifications of the starting voltage and time for the LCD panel but also can enhance the stability of the back light source, and especially can avoid the problems of the inverter's shut-down, the picture's flickering or the non-uniform display of the full white picture, when the back light source is turned on in a low-temperature environment.

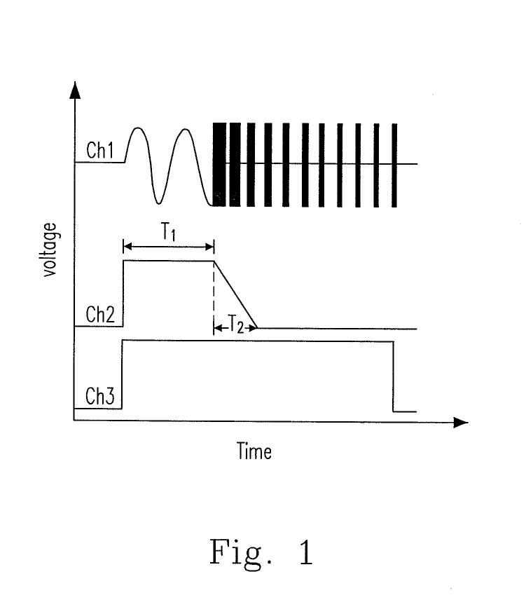

Please refer to FIG. 1, which shows the timing schedule for the voltage of the light source, the voltage of the brightness control and the voltage of the inverter when starting a display device in the first embodiment of the present invention. The Ch1 shows the voltage of the light source lamp, wherein the wave shape of this voltage is in the continued mode during the T₁ time period, and after then turns to be in the burst mode. The Ch2 shows the voltage of the brightness control, wherein the voltage is maintained at a maximum voltage, which corresponds to the maximum brightness of the display device, during the T₁ time period, and after then the voltage is gradually reduced to from the maximum voltage to a minimum voltage, which corresponds to the minimum brightness of the display device, during the T₂ time period. The Ch3 shows the control voltage of the inverter, wherein the voltage is maintained at a turn-on voltage when the light source lamp is turned on, no matter the maximum or minimum brightness. The above T₁ time period can be set to be longer than 0.5 second, and is set to 2 second in this embodiment so as to reach the technical efficacies mentioned in the previous paragraph. Of course, the T₁ time period can set to 1 second, 3 second or others, depending on the practical requirements to reach the same or similar efficacies. The T₂ time period can be set to be longer than 1 second so as to prevent the occurrence of the shut-down when the electrical current suddenly drops as the brightness is quickly reduced from high brightness to low brightness. Within the concept of the present invention, the T₂ time period can be appropriately adjusted according to the practical requirements.

### Second Embodiment

In this embodiment, when a display device, e.g. a lap-top computer, under a power-saving mode is initiated to be fully powered on, the driving unit, e.g. an inverter, of the back light source of the lap-top computer will drive the back light source to maintain the brightness at a maximum brightness for at least a specific period of time, e.g. longer than 0.5 second and set to 2 second in this embodiment. Similar to the first embodiment, the method in the present embodiment not only can conform to the specifications of the starting voltage and time for the LCD panel but also can enhance the stability of the back light source, and especially can avoid the issues that the lap-top computer is liable to shut down, malfunction, flicker or non-uniformly display the full white picture, when turned on in low temperature environment.

The display device can be an LCD monitor, a digital photo frame, an E-book or a video player besides the LCD TV and the lap-top computer as mentioned in the above first and second embodiments.

The back light source in the above first and second embodiments can be a cold cathode fluorescent lamp (CCFL) or other light source, e.g. light emitting diode (LED), etc. If the LED is used as a light source, the inverter to convert the direct current (DC) to alternating current (AC) is not required any more, since the LED adopts DC. Similarly, when the LED is used as the back light source in the above first and second embodiments, the driving unit will drive the back light source to maintain the brightness at the maximum brightness for at least a specific period of time, which can be set to be longer than 0.1 second and is set to 0.5 second or longer in the above embodiments.

In the above embodiments, the maximum brightness of the light source is defined as the maximum brightness at a voltage initiation of the light source.

### Third Embodiment

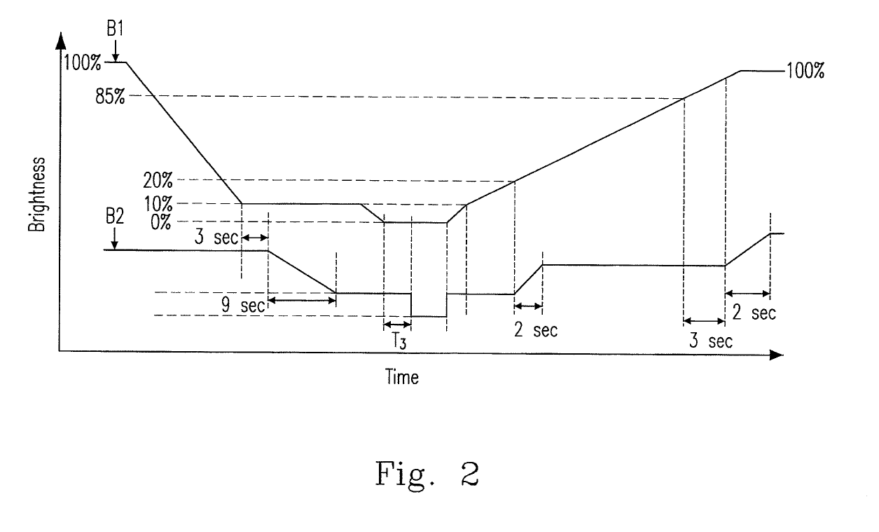

Please refer to FIG. 2, which shows the brightness of the display signal and that of the light source for a display device in the third embodiment of the present invention.

In FIG. 2, the B1 line represents the brightness of the display signal, i.e. the brightness of the picture to be shown according to the display signal. In this embodiment, the brightness of the display signal is 100% at the beginning, and then is gradually reduced to a minimum brightness, e.g. 10% in this embodiment. The B2 line represents the brightness of the back light source of the display device. The brightness of the back light source shown as the B2 line is continuously maintained at a maximum brightness until a buffer time, e.g. 3 second in the present embodiment, has passed right after the brightness of the display signal is reduced to the minimum brightness. Then, the brightness of the back light source shown as the B2 line starts to be gradually reduced to a minimum brightness during a adjusting time, e.g. 9 second in the present embodiment. The above buffer time of 3 second is designed to avoid the frequent adjustments of the back light source so as to prolong the lifetime of the back light source. The above adjusting time of 9 second is designed to avoid the problem that the user may be unable to see the picture clearly when the picture is suddenly darkened. Within the concept of the present invention, the above buffer time and adjusting time can be appropriately adjusted according to the practical requirements.

As shown in FIG. 2, the picture brightness of the display signal (B1 line) is further reduced to zero, and the back light source is turned off after another buffer time T₃ (e.g. longer than 0.5 second, set to 5 second in the present embodiment) following the time when the picture brightness of the display signal is reduced to zero. When the back light source is turned off, there is no electrical current entering the back light source, so the brightness of the back light source is down to zero as shown in B2 line of FIG. 2. At this moment, the brightness of the back light source is zero, and the dynamic contrast ratio can reach almost infinity, since the contrast ratio of a picture is defined as a ratio of the highest brightness of the picture to the lowest brightness of the picture. For the conventional LCD device, e.g. LCD TV, the back light source is always turned on and the liquid crystals are used as light valves to control the light passing or blocking. However, the polarization states of the liquid crystals and the polarization film can not be perfectly matched, so slight light leaking occurs for the completely dark picture. For instance, even when there is only 0.1% light leaking, the contrast ratio becomes 1000:1 (=100%/0.1%); when there is 0.5% light leaking, the contrast ratio is further down to 200:1 (=100%/0.5%). In contrast, the method of the present embodiment can promote the dynamic contrast ratio up to close to infinity, and accordingly greatly promote the display performance of the display device. Within the concept of the present invention, the above T₃ buffer time can be appropriately adjusted according to the practical requirements.

In the following time schedule, when the picture brightness of the display signal becomes higher than zero as shown in the B1 line of FIG. 2 or when a user inputs a signal, the back light source is immediately turned on to have the brightness equal to a minimum brightness, e.g. 10% brightness, of the display device so as to display the picture to be shown and also to avoid the problem of being harsh to the audience's eyes under too high brightness. The ways of inputting a signal by a user can include the actions of pressing a button of a remote controller, operating a joystick of a remote controller, moving a mouse, touching a touch panel or pressing a button of a keyboard. The minimum electrical current of the back light source can be set to 1.5 to 2.5 mA.

Some examples of the present invention are introduced in the followings.

In a first example of the present invention, a method for enhancing a contrast ratio of a picture having a picture brightness in a display device is provided. The method includes steps of providing the display device having a light source; continuously receiving plural display signals; and turning off the light source when the display device has a buffer time during which each of the continuously received plural display signals is representative of the respective picture brightness equal to zero.

In a second example of the present invention, the buffer time in the method of the first example is longer than 0.5 second.

In a third example of the present invention, the buffer time in the method of the first example is about 5 second.

In a fourth example of the present invention, the method of one of the preceding examples further includes a step of turning on the light source at a first brightness when the received display signal is representative of the respective picture brightness higher than zero and the light source is under a turn-off condition.

In a fifth example of the present invention, the first brightness in the method of one of the preceding examples is a minimum brightness set by the display device.

In a sixth example of the present invention, the display device in the method of one of the preceding examples has a minimum electric current for the minimum brightness, and the minimum electric current is in a range of 1.5 to 2.5 mA.

In a seventh example of the present invention, the method of one of the preceding examples further includes a step of turning on the light source at a first brightness when the display device receives a signal inputted by a user and the light source is under a turn-off condition.

In an eighth example of the present invention, the first brightness in the method of t one of the preceding examples is a minimum brightness set by the display device.

In a ninth example of the present invention, the display device in the method of one of the preceding examples has a minimum electric current for the minimum brightness, and the minimum electric current is in a range of 1.5 to 2.5 mA.

In a tenth example of the present invention, the inputted signal in the method of one of the preceding examples comes from an action made by the user, and the action includes one selected from a group consisting of pressing a button in a remote controller, operating a joystick in a remote controller, operating a mouse, touching a touch panel, and pressing a button in a keyboard.

In a eleventh example of the present invention, the display device in the method of one of the preceding examples includes one selected from a group consisting of a liquid crystal display (LCD) monitor, an LCD TV, a digital photo frame, a lap-top computer, an electronic book and a video player.

In a twelfth example of the present invention, a method for enhancing a stability of a light source of a display device is provided. The method includes providing the display device having the light source; and maintaining a maximum brightness of the light source for a specific period of time when the display device is initiated to be turned on.

In a thirteenth example of the present invention, the specific period of time in the method of one of the preceding examples is one of times larger than and equal to 0.5 second when the light source is a cold cathode fluorescent lamp (CCFL); and the specific period of time in the method of one of the preceding examples is one of times larger than and equal to 0.1 second when the light source is a light emitting diode (LED).

In a fourteenth example of the present invention, the specific period of time in the method of one of the preceding examples is one of times larger than and equal to 2 second when the light source is a CCFL; and the specific period of time in the method of one of the preceding examples is one of times larger than and equal to 0.5 second when the light source is an LED.

In a fifteenth example of the present invention, the display device in the method of one of the preceding examples is one selected from a group consisting of an LCD monitor, an LCD television, a digital photo frame, a lap-top computer, an electronic book and a video player.

In a sixteenth example of the present invention, the maximum brightness of the light source in the method of one of the preceding examples is a maximum brightness at a voltage initiation of the light source.

In a seventeenth example of the present invention, the display device in the method of one of the preceding examples includes a driving unit.

In an eighteenth example of the present invention, the driving unit in the method of one of the preceding examples turns on the light source and maintains the maximum brightness of the light source for the specific period of time.

In a nineteenth example of the present invention, the driving unit in the method of one of the preceding examples includes a rectifying device.

In a twentieth example of the present invention, the display device in the method of one of the preceding examples is initiated to be turned on from one of a shut-off condition and a power saving mode.

To sum up, the methods of enhancing the stability of the light source of the display device is provided in the present invention, and can avoid the problems of the violation of the specifications of the liquid crystal panel, the unsuccessful booting (or starting) of the display device, the inverter's shut-down, the picture's flickering, and the non-uniform display of the full white picture when the display device is initiated from the turn-off condition or the power-saving condition. In addition, the method of enhancing the contrast ratio of the display device is provided in the present invention, can promote the dynamic contrast ratio up to almost infinity, and can greatly promote the display performance of the display device.

While the invention has been described in terms of what is presently considered to be the most practical and preferred embodiments, it is to be understood that the invention needs not be limited to the disclosed embodiments. On the contrary, it is intended to cover various modifications and similar arrangements included within the concept and scope of the appended claims which are to be accorded with the broadest interpretation so as to encompass all such modifications and similar structures.

What is claimed is:

1. A method for enhancing a contrast ratio of a picture having a picture brightness in a display device, comprising steps of:
providing the display device having a light source;
continuously receiving plural display signals; and
turning off the light source when the display device has a buffer time during which each of the continuously received plural display signals is representative of the respective picture brightness equal to zero.

2. A method of claim 1, wherein the buffer time is longer than 0.5 second.

3. A method of claim 2, wherein the buffer time is about 5 second.

4. A method of claim 1, further comprising a step of:
turning on the light source at a first brightness when the received display signal is representative of the respective picture brightness higher than zero and the light source is under a turn-off condition.

5. A method of claim 4, wherein the first brightness is a minimum brightness set by the display device.

6. A method of claim 5, wherein the display device has a minimum electric current for the minimum brightness, and the minimum electric current is in a range of 1.5 to 2.5 mA.

7. A method of claim 1, further comprising a step of:
turning on the light source at a first brightness when the display device receives a signal inputted by a user and the light source is under a turn-off condition.

8. A method of claim 7, wherein the first brightness is a minimum brightness set by the display device.

9. A method of claim 8, wherein the display device has a minimum electric current for the minimum brightness, and the minimum electric current is in a range of 1.5 to 2.5 mA.

10. A method of claim 7, wherein the inputted signal comes from an action made by the user, and the action includes one selected from a group consisting of pressing a button in a remote controller, operating a joystick in a remote controller, operating a mouse, touching a touch panel, and pressing a button in a keyboard.

11. A method of claim 1, wherein the display device comprises one selected from a group consisting of a liquid crystal display (LCD) monitor, an LCD TV, a digital photo frame, a lap-top computer, an electronic book and a video player.

12. A method for enhancing a stability of a light source of a display device, comprising:
providing the display device having the light source; and
maintaining a maximum brightness of the light source for a specific period of time when the display device is initiated to be turned on.

13. A method of claim 12, wherein:
the specific period of time is one of times larger than and equal to 0.5 second when the light source is a cold cathode fluorescent lamp (CCFL); and
the specific period of time is one of times larger than and equal to 0.1 second when the light source is a light emitting diode (LED).

14. A method of claim 12, wherein:
the specific period of time is one of times larger than and equal to 2 second when the light source is a CCFL; and
the specific period of time is one of times larger than and equal to 0.5 second when the light source is an LED.

15. A method of claim 12, wherein the display device is one selected from a group consisting of an LCD monitor, an LCD television, a digital photo frame, a lap-top computer, an electronic book and a video player.

16. A method of claim 12, wherein the maximum brightness of the light source is a maximum brightness at a voltage initiation of the light source.

17. A method of claim 12, wherein the display device comprises a driving unit.

18. A method of claim 17, wherein the driving unit turns on the light source and maintains the maximum brightness of the light source for the specific period of time.

19. A method of claim 17, wherein the driving unit comprises a rectifying device.

20. A method of claim 12, wherein the display device is initiated to be turned on from one of a shut-off condition and a power saving mode.
